(19) United States
(12) Patent Application Publication
(10) Pub. No.: US 2026/0133675 A1
(43) Pub. Date: May 14, 2026

(54) Computing System and Method for Generating Construction-Based Data Objects Utilizing a Unified User Interface

(71) Applicant: Procore Technologies, Inc., Carpinteria, CA (US)

(72) Inventors: Madison Williams, Burnet, TX (US); Matt Man, Thornhill (CA)

(21) Appl. No.: 18/948,218

(22) Filed: Nov. 14, 2024

(51) Int. Cl. G06F 3/0484; G06F 3/0482

(52) U.S. Cl. CPC G06F 3/0484; G06F 3/0482

(57) ABSTRACT

A computing system is configured to: (i) cause a user to be presented with a unified user interface for creating data objects of multiple different types, (ii) cause the unified user interface to include a first set of input-control elements for a first set of data fields corresponding to a first type of data object, (iii) receive an indication that the selection of the type of data object to create has been changed from the first type of data object to a second type, (iv) cause the unified user interface to include a second set of input-control elements a second set of data fields corresponding to the second type, where a subset of the second set of data fields are pre-populated with a subset of the first set of values that were previously input based on a mapping between the first and second sets of data fields.

### BACKGROUND

Increasingly, parties involved in construction projects are beginning to use software applications to manage those construction projects. One example of such a software application is the software-as-a-service (SaaS) application for construction management offered by Procore Technologies, Inc. (“Procore”), who is the current applicant. Using construction management software applications such as these, parties can create a digital representation of a given construction project that is to be managed and then create, store, view, and/or interact with various types of digital project data associated with the given construction project. Such digital project data may include specifications, drawings, building information model (BIM) files, requests for information (RFIs), punch lists (e.g., which list work that has not yet been completed or has been completed incorrectly), risk management plans, safety plans, work breakdown structures, change orders, inspection documents (e.g., which record information about the results of inspections), construction submittals (e.g., mock-ups or other documents that contractors create to depict proposed plans), construction site observation reports, project management records (e.g., project schedules and project budgets), third-party records (e.g., applicable zoning restrictions, real-estate title records and purchase records, records of public hearings pertinent to the given construction project), directories, invoices, timesheets, meeting minutes, sensor data, and daily logs (e.g., which record information about each day work is done at a work site of the construction project), among many other examples of project data that may be stored for a construction project.

### SUMMARY

Disclosed herein is new software technology for generating construction-based data objects via a unified user interface that provides a user with input fields that correspond with each of a set of user-selectable types of construction-based data objects.

In one aspect, the disclosed technology may take the form of a method that involves (i) causing a user to be presented with a unified user interface for creating data objects of multiple different types, wherein the unified user interface comprises a type-selection input-control element that enables the user to input a selection of a type of data object to create, (ii) receiving an indication that the user has selected a first type of data object via the type-selection input-control element within the unified user interface, (iii) causing the unified user interface to be updated to include a first set of input-control elements for inputting values for a first set of data fields corresponding to the first type of data object, (iv) receiving an indication that the selection of the type of data object to create has been changed from the first type of data object to a second type of data object, (v) causing the unified user interface to be updated to include a second set of input-control elements for inputting values for a second set of data fields corresponding to the second type of data object, where at least a subset of the second set of data fields are pre-populated with at least a subset of the first set of values that were previously input by the user based on a mapping between the first and second sets of data fields, (vi) receiving a second set of one or more values for the second set of data fields that are input by the user via the second set of input-control elements, and (vii) creating the data object of the second type based on the first and second sets of values.

The foregoing method may further involve after receiving the first set of values for the first set of data fields, utilizing an artificial intelligence (AI) model to generate a prediction of which type of data object should be created based on an evaluation of the values input by the user. In an embodiment, the foregoing method may further involve, based on the prediction, updating the unified user interface to present a recommendation to the user to select the predicted type of data object. In another embodiment, the foregoing method may further involve, based on the prediction, automatically change the selection of the type of data object to create from the first type of data object to a second type of data object and correspondingly generate the indication that that the selection of the type of data object to create has been changed from the first type of data object to a second type of data object.

The AI model may take any of various forms. For example, the AI model may be a generative AI model.

The first and second sets of values for the first and second sets of data values may take any of various forms. For example, the first set of values for the first set of data fields may consist of values for less than all of the first set of data fields and the second set of values for the second set of data fields may consist of values for less than all of the second set of data fields.

The mapping between the first and second set of data fields may take any of various forms. For example, the mapping between the first and second sets of data fields may be a mapping between each of at least a subset of data fields in the first set and a corresponding data field in the second set.

The type-selection input-control element may take any of various forms. For example, the type-selection input-control element may be a dropdown list.

Each of the first set of input-control elements and the second set of input-control elements may take any of various forms. For example, the first set of input-control elements and the second set of input-control elements comprise at least one common data field having a same field name.

In another aspect, the disclosed technology may take the form of a computing system comprising at least one processor, at least one non-transitory computer-readable medium, and program instructions stored on the at least one non-transitory computer-readable medium that are executable by the at least one processor such that the computing platform is configured to carry out the functions of the aforementioned method.

In yet another aspect, the disclosed technology may take the form of a non-transitory computer-readable medium comprising program instructions stored thereon that are executable to cause a computing system to carry out the functions of the aforementioned method.

Features, aspects, and advantages of the presently disclosed technology may be better understood with regard to the following description, appended claims, and accompanying drawings, as listed below. The drawings are for the purpose of illustrating example embodiments, but those of ordinary skill in the art will understand that the technology disclosed herein is not limited to the arrangements and/or instrumentality shown in the drawings.

### BRIEF DESCRIPTION OF THE DRAWINGS

FIG. 1 depicts an example network configuration in which example embodiments may be implemented.

FIG. 2A depicts an example graphic user-interface (GUI) view of an Observations Tool of a construction management software application.

FIG. 2B depicts an example GUI view of a Punch List Tool of a construction management software application.

FIG. 3 depicts a flow diagram that illustrates example functionality for enabling a user to select a type of data object to create using a unified user interface.

FIG. 4A depicts an example of a GUI view that includes an option to access the unified user interface.

FIG. 4B depicts an example GUI view comprising a unified user interface that includes a dropdown list that enables the user to input a selection of a type of data object to create using the unified user interface.

FIG. 4C depicts an example GUI view comprising an updated instance of the unified user interface shown in FIG. 4B that now includes an example first set of input-control elements for a first set of data fields corresponding to a first type of data object.

FIG. 4D depicts an example GUI view that constitutes an alternative version of the GUI view of FIG. 4A, in which a separate type-selection input-control element is included.

FIG. 4E depicts an example GUI view that constitutes an alternative version of the GUI view of FIG. 4B.

FIG. 5 depicts a flow diagram that illustrates example functionality for updating the unified user interface so as to enable the user to input values for an updated set of data fields that correspond to a newly-selected type of data object while mapping any previously-entered values to the updated set of data fields.

FIG. 6A depicts an example GUI view comprising a unified user view in which a type-selection input-control element takes the form of a dropdown list.

FIG. 6B depicts an example GUI view comprising an updated instance of the unified user interface shown in FIG. 4C and/or FIG. 6A that now includes an example second set of input-control elements for a second set of data fields corresponding to a second type of data object.

FIG. 7 depicts a flow diagram that illustrates example functionality for predicting which type of data object should be created based on an evaluation of values for a data object to be created that are input by the user via the unified user interface and then using that prediction as a basis for facilitating the creation of the data object.

FIG. 8 depicts an example GUI view comprising a unified user interface that has been updated to include a recommendation to select a predicted type of data object as the type of data object to be created.

FIG. 9 is a simplified block diagram illustrating some structural components that may be included in an example computing platform that may be configured to perform some or all of the server-side functions disclosed herein.

FIG. 10 is a simplified block diagram illustrating some structural components that may be included in an example client device that may be configured to perform some or all of the client-side functions disclosed herein.

Features, aspects, and advantages of the presently disclosed technology may be better understood with regard to the following description, appended claims, and accompanying drawings, as listed below. The drawings are for the purpose of illustrating example embodiments, but those of ordinary skill in the art will understand that the technology disclosed herein is not limited to the arrangements and/or instrumentality shown in the drawings.

### DETAILED DESCRIPTION

The following disclosure refers to the accompanying figures and several examples. One of ordinary skill in the art would understand that such references are for the purpose of explanation only and are therefore not meant to be limiting. Part or all of the disclosed systems, devices, and methods may be rearranged, combined, added to, and/or removed in a variety of manners, each of which is contemplated herein.

As noted above, construction management today is often performed through the use of software applications, such as the software application for construction management provided by Procore Technologies, Inc.®, the applicant of the present disclosure. These construction management software applications generally provide users with the ability to create, store, view, and/or interact with various types of digital data related to a construction project. In practice, these construction management software applications may take various forms.

As one possible implementation, a construction management software application may include both front-end software (e.g., a web application, desktop application, or mobile application) running on client devices that are accessible to individuals associated with construction projects (e.g., contractors, project managers, architects, engineers, designers, etc.) and back-end software running on a back-end computing platform (sometimes referred to as a “cloud” platform) that interacts with and/or drives the front-end software, and which may be operated (either directly or indirectly) by the provider of the front-end software. This form of a software application may be referred to as a client-server application or a software-as-a-service (SaaS) application, among other possibilities. As another possible implementation, a construction management software application may include front-end software that runs on client devices without interaction with a back-end computing platform. These construction management software applications may take other forms as well.

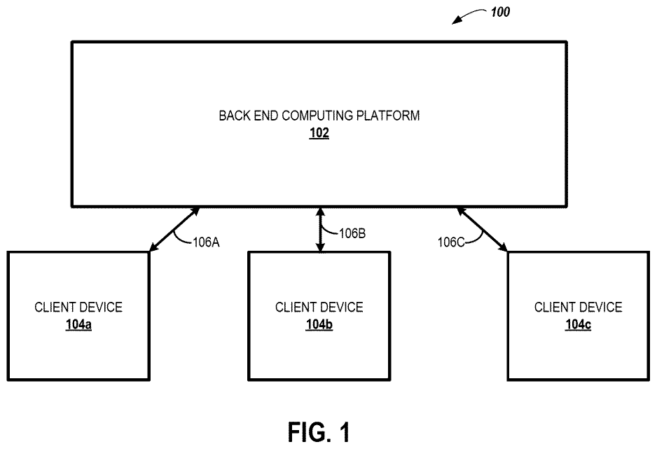

Turning now to the figures, FIG. 1 depicts an example network environment 100 in which a construction management software application may be implemented. As shown in FIG. 1, the network environment 100 includes a back-end computing platform 102 that may be communicatively coupled to one or more client devices 104, which as shown includes the client device 104A, the client device 104B, and the client device 104C. Although the client devices 104 are depicted by three devices as shown for the sake of simplicity in illustration, it should be understood that the client devices 104 may represent more or less than three devices without departing from the spirit and scope of this disclosure.

Broadly speaking, the back-end computing platform 102 may comprise one or more computing systems that have been provisioned with back-end software for a construction management software application, which may include program code for carrying out one or more of the platform-side functions disclosed herein. The one or more computing systems of back-end computing platform 102 may collectively comprise some set of physical computing resources (e.g., one or more processors, data storage system, communication interfaces, etc.), which may take various forms and be arranged in various manners.

For instance, as one possibility, the back-end computing platform 102 may comprise computing infrastructure of a public, private, and/or hybrid cloud (e.g., computing and/or storage clusters) that has been provisioned with back-end software for the construction management software application. In this respect, the entity that owns and operates the back-end computing platform 102 may supply its own cloud infrastructure or obtain the cloud infrastructure from a third-party provider of “on demand” computing resources, such as Amazon Web Services (AWS) or the like. As another possibility, the back-end computing platform 102 may comprise one or more dedicated servers that have been provisioned with back-end software for the construction management software application.

Further, in practice, the back-end software installed at the back-end computing platform 102 may be implemented using any of various software architecture styles, examples of which may include a microservices architecture, a service-oriented architecture, and/or a serverless architecture, among other possibilities, as well as any of various deployment patterns, examples of which may include a container-based deployment pattern, a virtual-machine-based deployment pattern, and/or a Lambda-function-based deployment pattern, among other possibilities.

Further yet, although not shown in FIG. 1, the back-end software installed at the back-end computing platform 102 may interact with a data storage layer of the back-end computing platform 102, which may comprise data stores of various different forms, examples of which may include relational databases (e.g., Online Transactional Processing (OLTP) databases), NoSQL databases (e.g., columnar databases, document databases, key-value databases, graph databases, etc.), file-based data stores (e.g., Hadoop Distributed File System), object-based data stores (e.g., Amazon S3), data warehouses (which could be based on one or more of the foregoing types of data stores), data lakes (which could be based on one or more of the foregoing types of data stores), message queues, or streaming event queues, among other possibilities.

The back-end computing platform 102 may comprise various other components and take various other forms as well.

In turn, the client devices 104 may each be any computing device that is capable of running front-end software of the construction management software application, which may include program code for carrying out the client-side functions disclosed herein. In this respect, the client devices 104 may each include hardware components such as one or more processors, computer-readable mediums, communication interfaces, and input/output (I/O) components (or interfaces for connecting thereto), among others, as well as software components that facilitate the client device's ability to run the front-end software (e.g., operating system software, web browser software, etc.). As representative examples, the client devices 104 may each take the form of a desktop computer, a spatial computer, a laptop, a netbook, a tablet, a smartphone, and/or a personal digital assistant (PDA), among other possibilities.

As further depicted in FIG. 1, the back-end computing platform 102 is configured to interact with the client devices 104 over respective communication paths 106, of which communication paths 106A, 106B, and 106C are shown as examples. In this respect, each respective communication path 106 between the back-end computing platform 102 and one of the client devices 104 may generally comprise one or more communication networks and/or communications links, which may take any of various forms. For instance, each respective communication path 106 with the back-end computing platform 102 may include any one or more of Personal Area Networks (PANs), Local-Area Networks (LANs), Wide-Area Networks (WANs) such as the Internet or cellular networks, cloud networks, and/or point-to-point links, among other possibilities. Further, the communication networks and/or links that make up each respective communication path 106 with the back-end computing platform 102 may be wireless, wired, or some combination thereof, and may carry data according to any of various different communication protocols. Further yet, communications over each respective communication path 106 could be carried out via an Application Programming Interface (API), among other possibilities. Still further, although not shown, the respective communication paths 106 between the client devices 104 and the back-end computing platform 102 may also include one or more intermediate systems. For example, it is possible that the back-end computing platform 102 may communicate with a given client device 104 via one or more intermediary systems, such as a host server (not shown). The respective communication paths 106 between the back-end computing platform 102 and the client devices 104 may take other forms as well.

Although not shown in FIG. 1, the back-end computing platform 102 may also be configured to receive data, such as data related to a construction project, from one or more external data sources, such as an external database and/or another back-end computing platform or platforms. Such data sources—and the data output by such data sources—may take various forms.

It should be understood that the network environment 100 depicted in FIG. 1 is one example of a network environment in a construction management software application may be implemented. Numerous other arrangements are possible and contemplated herein. For instance, other network configurations may include additional components not pictured and/or more or fewer of the pictured components.

When a given party (e.g., a company or individual involved in the construction industry) wishes to utilize an existing construction management software application, the given party may begin by (i) creating an account with the construction management software application and (ii) adding a set of one or more individuals associated with the given party as users on the given party's account. Thereafter, the construction management software application may enable the users of the given party to created, stored, viewed, and/or interacted with digital data related to construction projects that involve the given party.

For instance, for each of one or more construction projects that involve the given party, the construction management software application may enable users of the given party to create a new project workspace for the construction project (or join an existing project workspace for the construction project that was previously created) and then (ii) create, store, view, and/or interact with any of various types of data objects related to the construction project.

In practice, each different type of data object that is supported by a construction management software application may be designed to serve a particular purpose within the construction management software application and may comprise a particular set of data elements that facilitate that particular purpose. For instance, a first type of data object may be designed to serve a first purpose within the construction management software application and may comprise a first set of data elements, a second type of project-related data object may be designed to serve a second purpose within the construction management software application and may comprise a second set of data elements that differs from the first set of data elements, and so on for each of the other types of data objects. In this way, the users of the construction management software application may utilize different types of data objects to manage different aspects of the construction project. As some representative examples, the types of data objects that may be supported by a construction management software application may include observations data objects (e.g., a record of observed conditions and/or associated effects of said conditions during a construction project at a point in time during the course of the construction project), punch list and/or punch item data objects (e.g., a record of which list work on a construction project that has not yet been completed or has been completed incorrectly), daily log data objects (e.g., records of construction activity within a given timeframe, such as a day), request for information (RFI) data objects (e.g., a record of request for information from one user/party to another user/party and/or the information provided in response to said request), inspections data objects (e.g., a record of an inspection of a site at some point in time during the course of a construction project), among other types of construction-related data objects.

In at least some implementations, the software features for creating, storing, viewing, and/or interacting with the different types of data objects that are supported by a construction management software application may be arranged into different software “tools” that each correspond to a different type of data object. For instance, a construction management software application may include an “Observations” tool for creating, storing, viewing, and/or interacting with observation data objects, a “Punch Items/Lists” tool for creating, storing, viewing, and/or interacting with punch list and/or punch item data objects, a “Daily Logs” tool for creating, storing, viewing, and/or interacting with daily log data objects, a “RFIs” tool for creating storing, viewing, and/or interacting with RFI data objects, and/or an “Inspections” tool for creating, storing, viewing, and/or interacting with inspection data objects, among various other examples of software tools that may be included within a construction management software application. However, in other implementations, the software features for creating, storing, viewing, and/or interacting with the different types of data objects that are supported by a construction management software application may be arranged in other manners (e.g., software features that operate across multiple different types of data objects) that are not based solely on a software tools paradigm.

Further, in implementations where a construction management software application includes different software tools for creating, storing, viewing, and/or interacting with the different types of data objects, each such software tool may provide a dedicated user interface for creating data objects of the particular type that corresponds to the software tool (e.g., the Observations tool provides a first dedicated interface for creating observation data objects, the Punch Items/Lists tool provides a second dedicated interface for creating punch list and/or punch item data objects, etc.). Such a dedicated user interface for creating data objects of a given type may take the form of a particular graphical user interface (GUI) view (e.g., a particular GUI dialog) comprising a set of input-control elements through which users may input the particular set of data elements for the given type of data object. Such input-control elements could take any of various forms, examples of which may include a text field (e.g., a single-line text field or a multi-line text field), a selectable icon, a set of radio buttons, a set of check boxes, a slider (e.g., that allows a user to adjust a value within a range by moving a handle across a track), a date picker, an input stepper (e.g., a combination of a text box for displaying a value, a first button that increases the displayed value in response to being clicked, and a second button that decreases the displayed value in response to being clicked), a dropdown list, an uploader (e.g., a box into which a user can drag and drop a file to be uploaded or a combination of a button that triggers a display of a folder including candidate files to be uploaded and a text box that displays the name of a file selected for upload), and/or combinations thereof, among other possible examples of input-control elements.

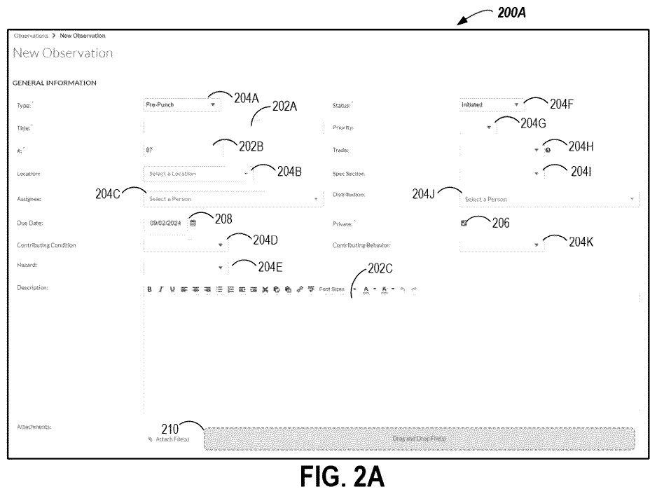

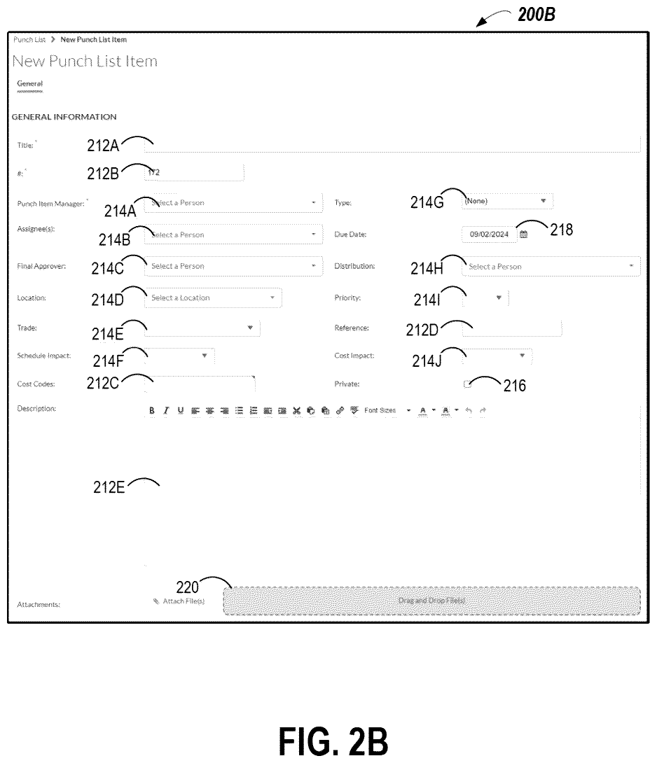

Turning to FIG. 2A, one illustrative example of a dedicated GUI view 200A for creating a new observation type of data object is shown. The dedicated GUI view 200A may be provided by an example Observations tool of a construction management software application. In line with the discission above, an observation type of data object may be a data object that is utilized to manage certain types of on-site items observed on a construction project that are referred to as “observations,” such as safety issues, quality deficiencies, work that needs to be done, and/or work that needs to be commissioned, among other things. For example, an observation type of data object may be utilized by parties involved a construction project to memorialize an observed on-site item that needs to be resolved, track the progress of an observed on-site item and coordinate actions for resolving the observed on-site item, among other things. To facilitate these tasks, an observation type of data object may comprise values for a particular set of data fields for the data elements that define an observation, such as a description for the observation, a type of observation for the observation, a title of the observation, an identifying number for the observation, a location for the observation, an assignee party for the observation, a date of the observation, a contributing condition for the observation, hazard information for the observation, a status of the observation, priority information for the observation, a trade that is associated with the observation, specification information that is associated with the observation, distribution information for the observation, privacy status for the observation, contributing behavior information for the observation, file attachments for the observation, etc.

As shown, the dedicated GUI view 200A for creating a new observation type of data object includes a set of input-control elements that enable a user to input values for a particular set of data fields for the data elements that are used to define an observation to be represented by the observation data object. For example, the dedicated GUI view 200A for creating an observation type of data object that represents a new observation is shown to include a dropdown list 204A that enables a user to input a type of the new observation, a text box 202A that enables a user to input a title of the new observation, a text box 202B that enables a user to input an identifying number for the new observation, a dropdown list 204B that enables a user to input a location for the new observation, a dropdown list 204C that enables a user to input an assignee party for the new observation, a date input element 208 that enables a user to input a date for the new observation, a dropdown list 204D that enables a user to input a contributing condition for the new observation, a dropdown list 204E that enables a user to input hazard information for the new observation, a dropdown list 204F that enables a user to input a status of the new observation, a dropdown list 204G that enables a user to input priority information for the new observation, a dropdown list 204H that enables a user to input a trade that is associated with the new observation, a dropdown list 204I that enables a user to input specification information that is associated with the new observation, a dropdown list 204J that enables a user to input information regarding distribution of the new observation, a checkbox 206 that enables a user to input privacy status for the new observation, a dropdown list 204K that enables a user to input contributing behavior information for the new observation, a text box 202C that enables a user to input information descriptive of the new observation, and an uploader 210 that enables a user to upload files (such as images, videos, recordings, etc.) for the new observation. The dedicated GUI view 200A may include various other input-control elements (not shown) for enabling a user to input data for the new observation, as well.

After the dedicated GUI view 200A is utilized to input the values for the new observation, the example Observations tool may create and store a new observation type of data object based on the values. Thereafter, other users of the construction management software application may view and/or interact with the new observation type of data object via the Observations tool (and/or any other tool or functionality of the construction management software application that allows for access of an observation type of data object).

As another example dedicated GUI view for generating another type of data object within the construction management software application, FIG. 2B shows one illustrative example of a dedicated GUI view 200B for creating a new punch item type of data object. The dedicated GUI view 200B may be provided by an example Punch Items/Lists tool of a construction management software application. In line with the discussion above, a punch item type of data object may be a data object that is utilized to present an item or task (referred to as a “punch item”) that should be or needs to be resolved prior to completion of a construction project. A set of punch item data objects may be grouped together to form a “punch list” data object that presents the set of punch items and their associated data objects.

Some examples of issues to be addressed as punch items may include incorrect work, missing work, sub-par work, mistakes in interpreting specifications, mistakes in quality, accidental damage, among other issues to be resolved prior to completion of a given construction project. To facilitate entry of documentation of punch items, a punch item type of data object may comprise values for a particular set of data fields that define data elements for a punch item, such as a description for the punch item, a title for the punch item, an identifying number for the punch item, a manager of the punch item, assignee(s) for the punch item, a final approver for the punch item, a location for the punch item, a trade associated with the punch item, schedule impact for the construction project associated with the punch item, one or more cost codes related to the punch item, a type for the punch item, a date for the punch item, a person to whom the punch item is to be distributed, priority information for the punch item, references associated with the punch item, cost impact information associated with the punch item, privacy status for the punch item, file attachments for the punch item, etc.

As shown, the dedicated GUI view 200B for creating a new punch item type of data object includes a set of input-control elements that enable a user to input values for a particular set of data fields that are used to define a punch item to be represented by the punch item type of data object. For example, the dedicated GUI view 200B for creating a punch item type of data object that represents a new punch item is shown to include a text box 212A that enables a user to input a title of the new punch item, a text box 212B that enables a user to input an identifying number of the new punch item, a dropdown list 214A that enables a user to input a manager of the new punch item, a dropdown list 214B that enables a user to input assignee(s) for the new punch item, a dropdown list 214C that enables a user to input a final approver for the new punch item, a dropdown list 214D that enables a user to input a location for the new punch item, a dropdown list 214E that enables a user to input a trade associated with the new punch item, a dropdown list 214F that enables a user to input schedule impact for the construction project due to the new punch item, a text box 212C that enables a user to input one or more cost codes related to the new punch item, a dropdown list 214G that enables a user to input a type for the new punch item, a date input element 218 that enables a user to input a date for the new punch item, a dropdown list 214H that enables a user to input a person to whom the new punch item is to be distributed, a dropdown list 214I that enables a user to input priority information for the new punch item, a text box 212D that enables a user to input information regarding references associated with the new punch item, a dropdown list 214J that enables a user to input cost impact information associated with the new punch item, a checkbox 206 that enables a user to input privacy status for the new punch item, a textbox 212E that enables a user to input information descriptive of the new punch item, and an uploader 220 that enables a user to upload files (such as images, videos, recordings, etc.) for the new punch item. The dedicated GUI view 200B may include various other input-control elements (not shown) for enabling a user to input data for the new punch item, as well.

After the dedicated GUI view 200B is utilized to input the data values for the new punch item, the example Punch Items/Lists tool may create and store a new punch item type of data object based on the data values. Thereafter, other users of the construction management software application may view and/or interact with the new punch item type of data object via the Punch Items/Lists tool (and/or any other tool or functionality of the construction management software application that allows for access of a punch item type of data object).

In practice, existing construction management software applications may have tens or perhaps of different software tools for managing different types of data objects, and each of those different software tools may have a different dedicated user interface for creating a respective type of data object within the construction management software application. However, this software design of having dedicated user interfaces for creating different types of data objects within a construction management software application gives rise to a number of problems.

For instance, when a construction management software application comprises software tools that include dedicated user interfaces for creating different types of data objects, a user is typically required to navigate through several different pages or screens (i.e., views) of the construction management software application's GUI in order to locate and access the dedicated user interface for creating a particular type of data object. For example, the user will first have to locate and access the appropriate software tool that corresponds to the particular type of data object, and will then have to locate and access the dedicated user interface for creating the particular type of data object within that software tool, which may require to navigate through multiple pages or screens of the construction management software application's GUI. This can be time consuming and inefficient, particularly when the user does not have a lot of experience using the construction management software application's GUI.

Further, if a user navigates to a dedicated user interface for a first type of data object, begins entering data values for the first type of data object, and then realizes part of the way through that the user actually needs to create a different, second type of data object, the user will have to close out of the dedicated user interface for creating the first type of data object, navigate to the dedicated user interface for creating the second type of data object (e.g., by navigating to a different, second software application and then locating and accessing the dedicated user interface for creating the second type of data object within the second software tool), and then entering data values for the second type of data object. In this respect, the values that the user entered for the first type of data object will be lost, and the user will have to re-enter those values into the appropriate fields of the dedicated user interface for the second type of data object, which is time consuming, inefficient, and increases the chances of error. Unfortunately, this scenario is not uncommon for users of existing construction management applications, because there are similarities between certain types of data objects that can lead users to navigate to the wrong software tool and begin creating the wrong type of data object before realizing the user's mistake.

To illustrate with a specific example, consider a construction management software application that includes the Observations tool and the Punch Lists/Items tool discussed above with respect to FIGS. 2A-2B. A user may first navigate to the dedicated GUI view 200A by locating and accessing the Observation tool and then locating and accessing the GUI view 200A that comprises the dedicated user interface for creating a new observation type of data object within the Observation tool. Once the user has accessed the GUI view 200A, the user may then begin using the input-control elements of the GUI view 200A to input values for the new observation type of data object.

After inputting certain values for the new observation type of data object, the user may then realize that the user has selected the wrong software tool and is creating the wrong the type of data object. For instance, the user may realize that the user should actually be creating a punch item type of data object but mistakenly began creating the observation type of data object instead (e.g., due to a misunderstanding of which type of data object was most appropriate for the user's task or a recognition after the fact that the punch item type of data object is best suited for the user's task). In this scenario, the user will then have to have to close out of the GUI view 200A—losing all of the values entered by the user in the process—and will then have to navigate to the Punch List tool, locate and access the GUI view 200B comprising the dedicated user interface for creating a punch item type of data object, and then begin re-entering values for the punch item type of data object.

Further yet, it is possible that the user may choose to create the wrong type of data object and then proceed all the way to the point of completing the creation process for the data object, which may result in the creation and storage of an erroneous data object that can lead to several downstream problems on a construction project, including unnecessary work (if someone tries to take action based on the erroneous data object when it was merely intended to memorialize the status of the construction project) or issues at a construction site that get missed (if the erroneous data object should have been of a type that served as an action item for another construction professional).

These are only some examples of problems that arise when a construction management software application comprises software tools that include dedicated user interfaces for creating different types of data objects.

It will also be appreciated that construction management software applications are often used by construction professionals while they are at a construction site (or traveling to or from a construction site), which compounds the problems described above because an inability to create new data objects in a quick and efficient manner while at a construction site can inhibit a construction professional's ability to do their job.

To address these and other problems associated with existing construction management software applications, disclosed herein is software technology for creating multiple different types of data objects within a construction management software application via a unified user interface.

The disclosed unified user interface may comprise (i) a type-selection input-control element for selecting a type of data object to create and (ii) a set of input-control elements for inputting values for a set of data fields that are associated with the selected type of data object. The type-selection input-control element may comprise any type of input-control element that enables a user to select a data-object type from a set of available data-object types, examples of which include a dropdown list, a text field that auto-populates one or more of a set of available data-object types in response to text input, a set of radio buttons, or a set of checkboxes, among other examples of input-control elements capable of providing a user with a way to select a data-object type to create via the unified user interface. Likewise, each of the set of input-control elements for inputting the values for the set of data fields that are associated with the selected type of data object may comprise any type of input-control element for inputting a data value, including but not limited to any of the types of input-control elements discussed above (e.g., text fields, dropdown lists, checkboxes, radio buttons, date pickers, uploaders, etc.).

Further, the functionality that is provided by the disclosed software technology in order to facilitate the creation of multiple different types of data objects via the disclosed unified user interface may take various forms. For instance, one aspect of the functionality that is provided by the disclosed software technology may include functionality that enables a user to select a type of data object to create via the disclosed unified user interface and then updates the unified user interface so as to enable the user to input values for a particular set of data fields that correspond to the selected type of data object. Such functionality may involve (i) causing a user to be presented with a unified user interface that is designed in accordance with the present disclosure, which may include a type-selection input-control element that enables the user to input a selection of a type of data object to create, (ii) receiving an indication that the user has selected a first type of data object via the type-selection input-control element within the unified user interface, (iii) causing the unified user interface to be updated so as to include a first set of input-control elements that enable the user to input values for a first set of data fields corresponding to the first type of data object, and (iv) thereafter receiving values for the first set of data fields (or at least a subset thereof) that have been input by the user via the first set of input-control elements.

Another aspect of the functionality that is provided by the disclosed software technology may include functionality that enables a user to change the user's selection of the type of data object to create and then updates the unified user interface so as to enable the user to input values for an updated set of data fields that correspond to the newly-selected type of data object, while mapping at least some of the previously-entered values to the updated set of data fields. Such functionality may involve (i) receiving an indication that the user has changed the user's selection of the type of data object to create from the first type of data object to a second type of data object, (ii) causing the unified user interface to be updated so as to include a second set of input-control elements that enable the user to input values for a second set of data fields corresponding to the second type of data object, where at least a subset of the second set of input-control elements are pre-populated with values that were previously input by the user for the first set of data fields based on a mapping between the first and second sets of data fields, and (iii) thereafter receiving values for the second set of data fields that have been input by the user via the second set of input-control elements.

Yet another aspect of the functionality that is provided by the disclosed software technology may include functionality that predicts which type of data object should be created based on an evaluation of values for a data object to be created that are input by the user via the unified user interface and then uses that prediction as a basis for facilitating the creation of the data object. Such functionality may involve (i) receiving values that are input by the user via the unified user interface for the data object to be created, (ii) utilizing an artificial intelligence (AI) model to predict which type of data object should be created based on an evaluation of the values input by the user, and then either (iii) updating the unified user interface to present a recommendation to the user to select the predicted type of data object or (iv) automatically selecting the predicted type of data object and updating the unified user interface to reflect this selection. In this respect, the prediction of which type of data object should be created may be made at a time when the user has not yet selected a type of data object to be created via the unified user interface, or at a time when the user had already previously selected a type of data object to be created via the unified user interface, in which case the prediction may lead to a change in the selected type of data object along with a change in the input-control elements that are included within the unified user interface.

The functionality that is provided by the disclosed software technology may take other forms as well.

The disclosed software technology improves upon the software technology for creating new data objects of different types that is included in existing construction management software applications in various ways. For instance, instead of requiring users to navigate to a different dedicated user interface for creating each different type of data object, the disclosed software technology enables users to navigate to a unified user interface through which the users can create any of multiple different types of data objects, which allows data objects to be created in a quicker and more efficient way. Further, if a user begins inputting values for a data object of a first type and decides part of the way through that the user should actually be creating a data object for a second type, the disclosed software technology enables users to change the type of data object to be created while retaining and re-mapping the values that were previously entered by the user such that the user does not have to re-enter those values. Further yet, if a user begins inputting values for a data object of a first type when the user should instead be inputting values for a data object of a second type, the disclosed software technology may intelligently determine that the wrong type of data object has been selected and then either present the user with a recommendation to change the type of data object or automatically change the selected type of data object so as to save the user from creating an erroneous data object of the wrong type. The improvements that are provided by the disclosed software technology are described in further detail below.

In practice, the disclosed software-based technology may be integrated into a construction management software application or provided as a standalone software tool, among other possibilities. For instance, as one possible implementation, the disclosed software-based technology may be integrated into a construction management software application comprising both front-end software running on client devices (e.g., client devices 104A-C of FIG. 1) that are accessible to individuals associated with construction projects (e.g., contractors, project managers, architects, engineers, designers, etc.) and back-end software running on a back-end computing platform (e.g., back-end computing platform 102 of FIG. 1) that interacts with and/or drives the front-end software. As another possible implementation, the disclosed software-based technology may be integrated into a construction management software application comprising front-end client software that runs on client devices without interaction with a back-end computing platform. The disclosed software technology may take other forms as well.

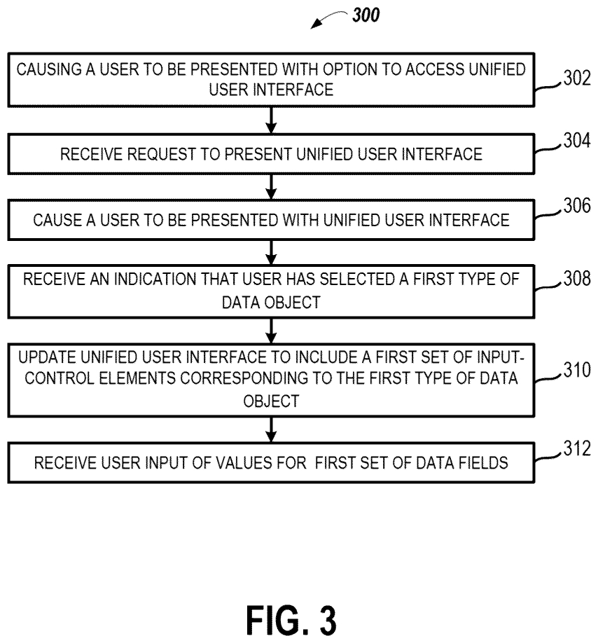

Turning now to FIG. 3, a flow diagram is shown that illustrates example functionality 300 for enabling a user to select a type of data object to create via the disclosed unified user interface and then updating the unified user interface so as to enable the user to input values for a particular set of data fields that correspond to the selected type of data object. For purposes of illustration, the example functionality 300 of FIG. 3 is described below as being carried out by a computing system that comprises (i) the back-end computing platform 102 running the back-end software for a construction management software application and (ii) a given one of the client devices running the front-end software for the construction management software application. In this respect, each of the functions described below may be carried out by the back-end computing platform 102, the client device 104, or a combination thereof. However, it should be understood that the example functionality 300 may be carried out by other types of computing systems as well (e.g., a standalone client device). Further, it should be understood that the example functionality of FIG. 3 is merely described in this manner for the sake of clarity and explanation and that the example functionality may be implemented in various other manners, including the possibility that functions may be added, removed, rearranged into different orders, combined into fewer blocks, and/or separated into additional blocks depending upon the particular example.

As shown in FIG. 3, the example functionality 300 may begin at block 302 with the computing system causing a user to be presented with an option to access an example of the disclosed unified user interface, which as noted above may facilitate creation of multiple different types of data objects within the construction management software application. The function of causing the user to be presented with the option to access the unified user interface may take any of various forms.

For instance, as one possibility, the function of causing the user to be presented with the option to access the unified user interface may involve (i) the back-end computing platform 102 transmitting a communication to the client device 104 that instructs the client device 104 to present the user with the option to access the unified user interface, (ii) the client device 104 receiving the communication, and (iii) the client device 104 thereafter presenting the user with the option to access the unified user interface (e.g., via a display screen controlled by the client device 104). In practice, this communication may take the form of one or more messages (e.g., one or more HTTP messages) that are sent over the communication path 106 between the back-end computing platform 102 and the client device 104 and, in at least some implementations, the communication may be sent via one or more APIs.

The function of causing the user to be presented with the option to access the example of the disclosed unified user interface may take various other forms as well.

Further, the option to access the unified user interface that is presented to the user may take any of various forms, such as a selectable input-control element that is presented on any of various GUI views within the construction management software application. For example, the selectable input-control element may take the form of a button or icon on a GUI view of the construction management software application (e.g., a homepage, a listing of software tools, etc.) that, when selected, causes the computing system to present the unified user interface. The selectable input-control element may be presented to the user in various other ways, such as via a banner that overlays all pages/views of the construction management software application. The option to access the unified user interface may take various other forms as well.

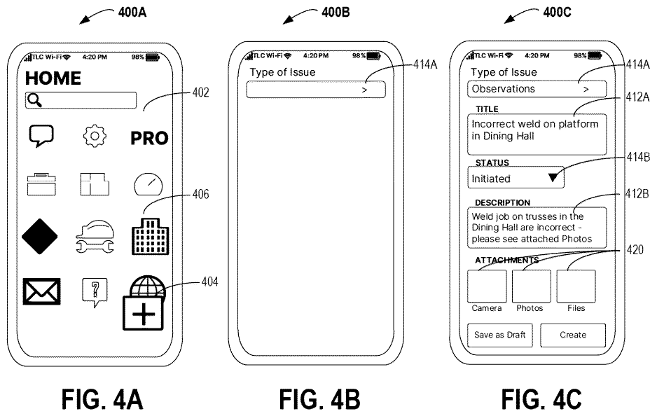

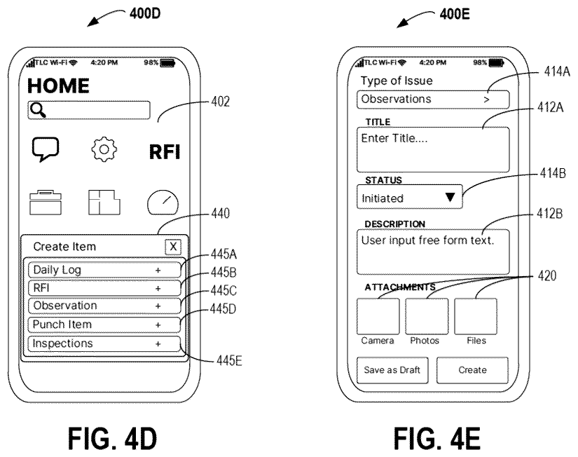

One illustrative example of a GUI view 400A that includes an option to access the unified user interface is shown in FIG. 4A. As shown, the GUI view 400A may comprise a “homepage”402 of the construction management software application that includes a selectable button 404 for accessing the unified user interface for creating data objects of different types. The selectable button 404 is one example of a selectable input-control element for accessing the unified user interface that may be presented to a user. However, the selectable input-control element may take various other forms, as discussed above.

After being presented with the option to access the unified user interface, the user may input a request to access the unified user interface into the client device 104. In turn, at block 304 of FIG. 3, the computing system may receive the user's request to access the unified user interface. For instance, the client device 104 may receive the user's request to access the unified user interface via one or more I/O components of the client device 104, and the client device 104 may then transmit a communication the encodes the user's request to access the unified user interface to the back-end computing platform 102, which may thereafter receive the communication. In practice, this communication may take the form of one or more messages (e.g., one or more HTTP messages) that are sent over the communication path 106 between the client device 104 and the back-end computing platform 102 and, in at least some implementations, the communication may be sent via one or more APIs.

The function of receiving the user's request to access the unified user interface may take various other forms as well.

At block 306, after receiving the user's request to access the unified user interface, the computing system may cause the user to be presented with the unified user interface for creating multiple different types of data objects. This function of causing the user to be presented with the unified user interface may take any of various forms.

For instance, as one possibility, the function of causing the user to be presented with the unified user interface may involve (i) the back-end computing platform 102 transmitting a communication to the client device 104 that instructs the client device 104 to present the user with the unified user interface, (ii) the client device 104 receiving the communication, and (iii) the client device 104 thereafter presenting the user with the unified user interface (e.g., via a display screen controlled by the client device 104). In practice, this communication may take the form of one or more messages (e.g., one or more HTTP messages) that are sent over the communication path 106 between the back-end computing platform 102 and the client device 104 and, in at least some implementations, the communication may be sent via one or more APIs.

The function of causing the user to be presented with the unified user interface may take various other forms as well.

In line with the discussion above, the unified user interface that is presented to the user at block 306 may comprise (i) a type-selection input-control element that enables the user to input a selection of a type of data object to create and perhaps also (ii) a set of input-control elements that enable the user to input values for a set of data fields that are associated with the selected type of data object. However, prior to the type of data object being selected, it is possible that the unified user interface either (i) may not include any input-control elements for inputting values for a set of data fields or (ii) may initially include a baseline set of input-control elements that can be utilized to input values for a baseline set of data fields that are expected to be common across various different types of data objects (e.g., title/name, description, due date, assignee, status, etc.) and may then be updated after the type of data object been selected so as to include a set of input-control elements for the selected type's corresponding set of data fields—in which case the values input for the baseline set of data fields may be mapped to the appropriate data fields and pre-populated within the appropriate input-control elements as part of the updating.

One illustrative example of a GUI view 400B comprising a unified user interface is shown in FIG. 4B. As shown, the GUI view 400B may comprise a dropdown list 414A that enables the user to input a selection of a type of data object to create using the unified user interface. The dropdown list 414A is one example of a selectable input-control element (e.g., a drop down list) for inputting a selection of a type of data object to create using the unified user interface. However, the type-selection input control element may take various other forms, as discussed herein.

In some implementations, the computing system may also dynamically filter the object-type options that are included within the dropdown list 414A based on an analysis of the user's interaction with the construction management software application. For instance, as the user interacts with the construction management software application, the computing system may function to analyze the user's interaction (e.g., the user's actions within the application, the user's location while interacting with the application, the data that is presented to the user, etc.), which may provide insight into the user's past, current, and/or future intent (e.g., the actions that the user is most likely to take next), and the computing system may then use this analysis as a basis for filtering the object-type options that are included within the dropdown list 414A so as to present the user with a more targeted set of object-type options that are tailored to what the user is most likely trying to accomplish within the construction management software application, which may further improve user experience. In practice, the computing system perform this analysis using an AI model to predict the user's past, current, and/or future intent and/or a semantic matching of the user's past, current, and/or future intent, among other possibilities.

After the unified user interface is presented to the user at block 306, the user may input a selection of a first type of data object into the unified user interface, which may involve interacting with the type-selection input-control element of the unified user interface in order to select an available data-type option. For example, the user may input the selection of the first type of data object by tapping, clicking on, and/or typing within the type-selection input-control element included in the unified user interface, among other possible ways that the user may input the selection of the first type of data object into the unified user interface (e.g., a voice-based selection of the first type of data object).

In turn, at block 308, the computing system may receive the user's selection of the first type of data object that is input into the unified user interface. For instance, the client device 104 may receive the user's selection of the first type of data object via one or more I/O components of the client device 104, and in at least some implementations, the client device 104 may then transmit a communication the encodes the user's selection of the first type of data object to the back-end computing platform 102, which may thereafter receive the communication. In practice, this communication may take the form of one or more messages (e.g., one or more HTTP messages) that are sent over the communication path 106 between the client device 104 and the back-end computing platform 102 and, in at least some implementations, the communication may be sent via one or more APIs.

The function of receiving the user's selection of the first type of data object may take various other forms as well.

At block 310, after the user's selection of the first type of data has been received, the computing system may cause the unified user interface to be updated so as to include a first set of input-control elements that enable the user to input values for a first set of data fields corresponding to the first type of data object. This function of causing the unified user interface to be updated so as to include the first set of input-control elements may take any of various forms.

In one implementation, the function of causing the unified user interface to be updated so as to include the first set of input-control elements may begin with the computing system determining the first set of data fields that correspond to the first type of data object. This function may be carried out by either the back-end computing platform 102 or the client device 104, and may take any of various forms. For instance, as one possibility, the function of determining the first set of data fields that correspond to the first type of data object may involve (i) accessing a data map that maps data-object types to their corresponding sets of data fields, (ii) locating the first type of data object within the data map, and (iii) determining that the first type of data object's corresponding set of data fields within the data map is the first set of data fields. In this respect, the data map may be stored within a data storage layer that stores the data map for the unified user interface of the back-end computing platform 102 and/or the local data storage of the client device 104, among other possibilities.

The function of determining the first set of data fields that correspond to the first type of data object may take other forms as well.

After determining the first set of data fields that correspond to the first type of data object, the computing system may next determine the first set of input-control elements to include in the unified user interface so as to enable the user to input values for the first set of data fields. This function may be carried out by either the back-end computing platform 102 or the client device 104, and may take any of various forms. For instance, as one possibility, the function of determining the first set of input-control elements to include in the unified user interface may involve evaluating the first set of data fields to determine, for each respective data field in the first set, a respective input-control element that is to be utilized for the respective data field. In this respect, the determination of a respective input-control element that is to be utilized for a respective data field may involve accessing and using a data map that maps data fields to their corresponding input-control elements (which could be the same data map described above or a separate data map) and/or evaluating a type of the respective data field (which may be encoded in the data map described above or in some other manner), among other possible ways that the computing system may determine the respective input-control element that is to be utilized for the respective data field.

The function of determining the first set of input-control elements to include in the unified user interface so as to enable the user to input values for the first set of data fields may take other forms as well, including but not limited to the possibility that this function may also involve determining how the first set of input-control elements are to be arranged within the unified user interface.

After determining the first set of input-control elements to include in the unified user interface, the computing system may then cause the unified user interface to be updated to include the first set of input-control elements determined by the computing system. This function may likewise take various forms. For instance, in an implementation where the back-end computing platform 102 determines the first set of input-control elements to include in the unified user interface, this function may involve (i) the back-end computing platform 102 transmitting a communication to the client device 104 that instructs the client device 104 to update the unified user interface to include the first set of input-control elements, (ii) the client device 104 receiving the communication, and (iii) the client device 104 thereafter updating the unified user interface such that it includes the first set of input-control elements. In practice, this communication may take the form of one or more messages (e.g., one or more HTTP messages) that are sent over the communication path 106 between the back-end computing platform 102 and the client device 104 and, in at least some implementations, the communication may be sent via one or more APIs. Alternatively, in an implementation where the client device 104 determines the first set of input-control elements to include in the unified user interface, this function may involve the client device 104 updating the unified user interface such that it includes the first set of input-control elements determined locally by the client device 104.

The function of causing the unified user interface to be updated to include the first set of input-control elements determined by the computing system may take other forms as well, including but not limited to the possibility that the function of causing the unified user interface to be updated to include the first set of input-control elements determined by the computing system may involve updating the unified user interface from a baseline set of input-control elements for a baseline set of data fields to the first set of input-control elements for the first set of data fields, which as noted above may involve mapping the values input for the baseline set of data fields the appropriate data fields in the first set and pre-populating those values within the appropriate input-control elements in the first set.

To illustrate with an example, FIG. 4C illustrates a GUI view 400C comprising an updated instance of the unified user interface shown in FIG. 4B that now includes an example first set of input-control elements for the first set of data fields corresponding to the first type of data object, which is an observation type of data object in this example. As shown, the example first set of input-control elements may include, but are not limited to including, a text box 412A that enables the user to input a title for the observation type of data object, a dropdown list 414B that enables the user to input an indication of a status for the observation type of data object, a text box 412B that enables the user to input a description for the observation type of data object, and one or more uploaders 420 that enable the user to upload files (such as images, videos, recordings, etc.) for the observation type of data object, among other possible input-control elements that may be included for other possible data fields corresponding to the observation type of data object.

In some implementations, in addition to or in alternative to enabling the user to select the first type of data object to be created via the type-selection input-control element of the unified user interface and then updating the unified user interface to include the first set of input-control elements, the computing system may enable the user to select the first type of data object to be created at other times and in other manners as well.

For instance, as one possibility, the construction management software application may include an AI-powered digital assistant that may present the user with a question such as “What type of data object would you like to create?” at any of various points during the user's interaction with the construction management software application, examples of which may include (i) when the user is on a home page or screen of the construction management software application, (ii) when the user selects the option to access the unified user interface, and/or (iii) when the user takes any other action within the construction management software application that leads the AI-powered digital assistant to predict that the user may be interested in creating a new data object. In this respect, if the user responds to the question presented by the AI-powered digital assistant (e.g., via a typed or spoken response) by identifying a given type of data object that the user wishes to create, the computing system may interpret that response as a selection of the given type of data object and may then pre-populate the unified user interface that is presented to the user with (i) the user's selection of the given type of data object and (ii) a set of input-control elements corresponding to the given type of data object.

As another possibility, as part of presenting the user with the option to access the unified user interface at block 302, the computing system may present the user with an option to select the first type of data object to be created via a separate type-selection input-control element that is presented to the user in advance of presenting the unified user interface itself (e.g., a dropdown list, a set of selectable buttons, etc. that is presented on a separate GUI view), which may enable the user to select the first type of data object as part of the user's request to access the unified user interface. And if the user does select the first type of data object as part of the user's request to access the unified user interface, the computing system may receive that selection along with the user's request to access the unified user interface and may then pre-populate the unified user interface that is presented to the user with (i) the user's prior selection of the first type of data object and (ii) the first set of input-control elements corresponding to the first type of data object.

To illustrate with an example, FIG. 4D shows a GUI view 400D that constitutes an alternative version of the GUI view 400A in which a separate type-selection input-control element 440 comprising a set of selectable buttons 445A-E is included so as to allow the user to select the first type of data object as part of the user's request to access the unified user interface. As shown in FIG. 4D, The set of selectable buttons 445 may be present the user with a listing of types of data objects, which can be generated via the unified user interface, by having each of the selectable buttons 445 labelled with a respective type of data object that will be input as the first type of data object, upon selection of that respective selectable button 445 (e.g., selection of button 445A will indicate selection of a “daily log” type of data object as the first type of data object, selection of button 445B will indicate selection of an “RFI” type of data object as the first type of data object, selection of button 445C will indicate selection of an observation type of data object as the first type of data object, selection of button 445D will indicate selection of a punch item type of data object as the first type of data object, selection of button 445E will indicate selection of an inspection type of data object as the first type of data object).

If the user chooses to use the set of selectable buttons 445 to select a given type of data object as the first type of data object to be created using the unified user interface, the computing system may receive that selection along with the user's request to access the unified user interface and may then pre-populate the unified user interface that is presented to the user with (i) the user's prior selection of the first type of data object and (ii) the first set of input-control elements corresponding to the first type of data object. To illustrate with an example, FIG. 4E shows a GUI view 400E that constitutes an alternative version of the GUI view 400B in which the unified user interface has been pre-populated with (i) the user's selection of the first type of data object that was input into the GUI view 400C, which in this example is an observation type of data object as shown in the dropdown list 414A of the unified user interface, and (ii) a set of input-control elements corresponding to the selected observations type of data object.

In still other implementations, the user's selection of the first type of data object may be input via a chat-type interface that enables the user to input text-based and/or voice-based natural language requests.

Returning to the discussion of FIG. 3, after the unified user interface is updated at block 310 to include the first set of input-control elements that enable the user to input values for a first set of data fields corresponding to the first type of data object, the user may input values into the unified user interface. In practice, this may take the form of the user interacting with the input-control elements of the unified user interface in order to input the values for the first set of data fields corresponding to the first type of data object. For example, the user may input the values for the first set of data fields by tapping, clicking on, or typing within the first set of input-control elements, among other possible ways that the user may input values into the unified user interface (e.g., a voice-based input). To illustrate with an example, FIG. 4E shows a GUI view 400E comprising an updated instance of the unified user interface wherein of the user has used some of the first set of input-control elements (e.g., the text box 412A, the text box 412B) to input values for some of the data fields corresponding to the observation type of data object.

In some implementations, the computing system may also function to predict values for certain data fields within the unified user interface and automatically populate such values within the input-control elements of the unified user interface based on an analysis of the user's interaction with the construction management software application. For instance, as the user interacts with the construction management software application, the computing system may function to analyze the user's interaction (e.g., the user's actions within the application, the user's location while interacting with the application, the data that is presented to the user, etc.), which may provide insight into the user's past, current, and/or future intent (e.g., the actions that the user is most likely to take next), and the computing system may then use this analysis as a basis for predicting values for certain data fields within the unified user interface and automatically populating such values within the input-control elements of the unified user interface, which may further improve user experience. In practice, the computing system perform this analysis using an AI model to predict the user's past, current, and/or future intent and/or a semantic matching of the user's past, current, and/or future intent, among other possibilities.

At block 312 of FIG. 3, the computing system may then receive values for at least some data fields of the data object to be created that have been input by the user into the unified user interface (e.g., via the first set of input-control elements included within the unified user interface). For instance, the client device 104 may receive the user's input of the values for the data object to be created via one or more I/O components of the client device 104, and in at least some implementations, the client device 104 may then transmit a communication the encodes the user's input of the values for the data object to be created to the back-end computing platform 102, which may thereafter receive the communication. In practice, this communication may take the form of one or more messages (e.g., one or more HTTP messages) that are sent over the communication path 106 between the client device 104 and the back-end computing platform 102 and, in at least some implementations, the communication may be sent via one or more APIs.

The function of receiving values for the data object to be created that have been input by the user into the unified user interface may take various other forms as well.

After the user begins inputting values for the data object to be created into the unified user interface, the unified user interface may enable the user to proceed along one of a few different paths related to the creation of the data object.

For instance, as a first possible path, the unified user interface may enable the user to input values for all required data fields of the data object of the first type and then input a request to create the data object, and to facilitate this path, the computing system may function to (i) receive the request to create the data object, and then (ii) create the data object of the first type based on the values into by the user into the unified user interface. For instance, the client device 104 may receive the user's request to create the data object via one or more I/O components of the client device 104, and the client device 104 may in turn transmit a communication the encodes the user's request to create the data object (perhaps along with some or all of the values input by the user to the extent that they were not sent previously) to the back-end computing platform 102, which may thereafter receive the communication and then create the data object based on the values input by the user into the unified user interface. In practice, this communication may take the form of one or more messages (e.g., one or more HTTP messages) that are sent over the communication path 106 between the client device 104 and the back-end computing platform 102 and, in at least some implementations, the communication may be sent via one or more APIs. Additionally, the back-end computing platform 102 may store the newly-created data object for use and/or access by users of the construction management software application within a data storage layer of the back-end computing platform 102.

Alternatively, as a second possible path, the unified user interface may enable the user to change the user's selection of the type of data object to be created before completing the creation process, and to facilitate this path, the computing system may function to update the unified user interface so as to enable the user to input values for an updated set of data fields that correspond to the newly-selected type of data object while mapping any previously-entered values to the updated set of data fields.

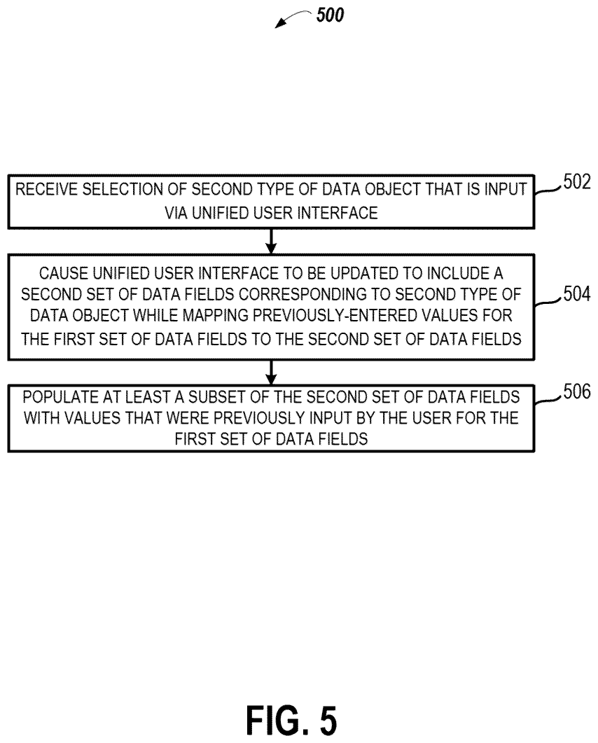

Turning now to FIG. 5, a flow diagram is shown that illustrates example functionality 500 for updating the unified user interface so as to enable the user to input values for an updated set of data fields that correspond to a newly-selected type of data object while mapping any previously-entered values to the updated set of data fields. For purposes of illustration, the example functionality 500 of FIG. 5 is described below as being carried out by a computing system that comprises (i) the back-end computing platform 102 running the back-end software for a construction management software application and (ii) a given one of the client devices running the front-end software for the construction management software application. In this respect, each of the functions described below may be carried out by the back-end computing platform 102, the client device 104, or a combination thereof. However, it should be understood that the example functionality 500 may be carried out by other types of computing systems as well (e.g., a standalone client device). Further, it should be understood that the example functionality of FIG. 5 is merely described in this manner for the sake of clarity and explanation and that the example functionality may be implemented in various other manners, including the possibility that functions may be added, removed, rearranged into different orders, combined into fewer blocks, and/or separated into additional blocks depending upon the particular example.

The example functionality 500 may pick up after block 312 of FIG. 3, which involves the computing system receiving values for at least some data fields of the data object to be created that have been input by the user into the unified user interface at a time when the type of data object is set to the first type of data object that was selected by the user in one of the manners described above.

As noted above, after the user has begun inputting values for the data object to be created into the unified user interface, the user may decide to change the user's selection of the type of data object from the first type of data object to a second type of data object. In such a scenario, the user may then input a request to change the user's selection of the type of data object to be created from the first type of data object to the second type of data object. For instance, the user may interact with the type-selection input-control element of the unified user interface in order to unselect the first type of data object and instead select the second type of data object, among other possible ways that the user may input the request to change from the first type of data object to the second type of data object.

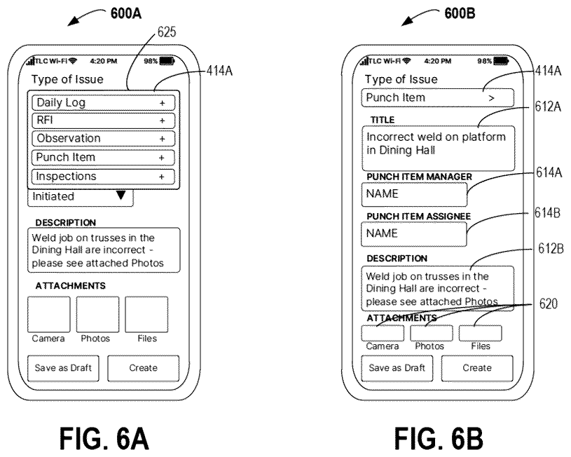

To illustrate with an example, FIG. 6A shows an example GUI view 600A comprising a unified user view in which the type-selection input-control element takes the form of a dropdown list 414A. As shown, the user may interact with the dropdown list 414A (e.g., by clicking on an unexpanded view of the dropdown list 414A via an I/O component of the client device 104) such that an expanded view 625 of the dropdown list 414A is shown. In the expanded view 625, a listing of available types of data objects (e.g., a “daily log” type of data object, an “RFI” type of data object, an “observation” type of data object, a “punch item” type of data object, an “inspection” type of data object, etc.) is shown and each type can be selected via user input. This is one example type-selection input-control element that can both enable a user to input the initial, first type of data object and input a request to change to the second type of data object.

The user's request to change the user's selection of the type of data object to be created from the first type of data object to the second type of data object may be input in other manners as well, including but not limited to the possibility that the user's request may be input via a chat-type interface that enables the user to input text-based and/or voice-based natural language requests.

In some implementations, the computing system may also dynamically filter the object-type options that are included within the expanded view 625 of the dropdown list 414A based on an analysis of the user's interaction with the construction management software application after having selected the first type of data object. For instance, as the user interacts with the construction management software application, the computing system may function to analyze the user's interaction (e.g., the textual content of the data values entered into the first set of data fields, etc.), which may provide insight into the user's past, current, and/or future intent (e.g., the actions that the user is most likely to take next), and the computing system may then use this analysis as a basis for filtering the object-type options that are included within the expanded view 625 of the dropdown list 414A so as to present the user with a more targeted set of object-type options that are tailored to what the user is most likely trying to accomplish within the construction management software application, which may further improve user experience. In practice, the computing system perform this analysis using an AI model to predict the user's past, current, and/or future intent and/or a semantic matching of the user's past, current, and/or future intent, among other possibilities.

As shown in FIG. 5, the example functionality 500 may then begin at block 502 with the computing platform receiving the user's request to change the user's selection of the type of data object to be created from the first type of data object to a second type of data object. For instance, the client device 104 may receive the user's request to change from the first type of data object to the second type of data object via one or more I/O components of the client device 104, and in at least some implementations, the client device 104 may then transmit a communication the encodes the user's request to change from the first type of data object to the second type of data object to the back-end computing platform 102, which may thereafter receive the communication. In practice, this communication may take the form of one or more messages (e.g., one or more HTTP messages) that are sent over the communication path 106 between the client device 104 and the back-end computing platform 102 and, in at least some implementations, the communication may comprise be sent via one or more APIs.

The function of receiving the user's request to change from the first type of data object to the second type of data object take various other forms as well.

At block 504, receiving the user's request to change the user's selection of the type of data object to be created from the first type of data object to the second type of data object, the computing system may cause the unified user interface to be updated so as to include a second set of input-control elements that enable the user to input values for a second set of data fields corresponding to the second type of data object while mapping previously-entered values for the first set of data fields to the second set of data fields. This function take any of various forms.

In one implementation, the function of causing the unified user interface to be updated so as to include the second set of input-control elements may begin with the computing system determining the second set of data fields that correspond to the first type of data object. This function may be carried out by either the back-end computing platform 102 or the client device 104, and may take any of various forms. For instance, as one possibility, the function of determining the second set of data fields that correspond to the second type of data object may involve (i) accessing a data map that maps data-object types to their corresponding sets of data fields, (ii) locating the second type of data object within the data map, and (iii) determining that the second type of data object's corresponding set of data fields within the data map is the second set of data fields. In this respect, the data map may be stored within a data storage layer of the back-end computing platform 102 and/or the local data storage of the client device 104, among other possibilities.

The function of determining the second set of data fields that correspond to the second type of data object may take other forms as well.

After determining the second set of data fields that correspond to the second type of data object, the computing system may determine the second set of input-control elements to include in the unified user interface so as to enable the user to input values for the second set of data fields. This function may be carried out by either the back-end computing platform 102 or the client device 104, and may take any of various forms. For instance, as one possibility, the function of determining the second set of input-control elements to include in the unified user interface may involve evaluating the second set of data fields to determine, for each respective data field in the second set, a respective input-control element that is to be utilized for the respective data field. In this respect, the determination of a respective input-control element that is to be utilized for a respective data field may involve accessing and using a data map that maps data fields to their corresponding input-control elements (which could be the same data map described above or a separate data map) and/or evaluating a type of the respective data field (which may be encoded in the data map described above or in some other manner), among other possible ways that the computing system may determine the respective input-control element that is to be utilized for the respective data field.

The function of determining the second set of input-control elements to include in the unified user interface so as to enable the user to input values for the second set of data fields may take other forms as well, including but not limited to the possibility that this function may also involve determining how the second set of input-control elements are to be arranged within the unified user interface.

After determining the second set of data fields that correspond to the second type of data object, the computing system may also map at least some of the previously-entered values for the first set of data fields to the second set of data fields. This function may be carried out by either the back-end computing platform 102 or the client device 104, and may take any of various forms. For instance, as one possibility, the function of mapping at least some of the previously-entered values for the first set of data fields to the second set of data fields may involve accessing a data map that indicates how data fields for different data objects map to one another (which could be the same data map used to determine the set of data fields for the selected data-object type or a different data map), and then for each respective data field in the first set for which the user previously input a value, (i) using the data map to determine whether the respective data field in the first set maps to a corresponding data field in the second set, and (ii) if so, assigning the previously-input value for the respective data field in the first set to the corresponding data field in the second set and thereby causing the previously-input value to be populated into the input-control element for the corresponding data field in the second set. In this respect, the data fields that are mapped between different data objects could have the same field name (e.g., title, description, etc.), or could have different field names but nevertheless be considered to represent the same type of information (e.g., an owner field of a type of data object could be mapped to an assignee field of another type of data object), among other possible mappings of data fields between different data objects.

To illustrate with an example, consider a data value is input to a first data field of the first set of data fields, via one of the first set of input-control elements, and the data map indicates that the first data field of the first set of data fields is mapped to a second data field of the second set of data fields. Then, if the type of data object is changed from the first type of data object to the second type of data object, the computing system will map the value that was input for the first data field of the first set of data fields to the second data field of the second set of data fields and then populate the mapped value within the input-control element that is included in the unified user interface for the second data field. To the user, this may appear as if the unified user interface has “kept” the values input for the data fields in the first set that map to data fields in the second set (as input to input-control elements for the data fields in the second set), while including input-control elements for any other data field in the second set of data field that is not mapped to a data field in first set of data fields.

After determining the second set of input-control elements to include in the unified user interface and mapping at least some of the previously-entered values for the first set of data fields to the second set of data fields, the computing system may then cause the unified user interface to be updated to include the second set of input-control elements determined by the computing system along with any previously-entered values that are to be pre-populated into the second set of input-control elements. This function may likewise take various forms. For instance, in an implementation where the back-end computing platform 102 determines the second set of input-control elements to include in the unified user interface, this function may involve (i) the back-end computing platform 102 transmitting a communication to the client device 104 that instructs the client device 104 to update the unified user interface to include the second set of input-control elements along with any previously-entered values that are to be pre-populated into the second set of input-control elements, (ii) the client device 104 receiving the communication, and (iii) the client device 104 thereafter updating the unified user interface such that it includes the second set of input-control elements and the previously-entered values that are to be pre-populated into the second set of input-control elements. In practice, this communication may take the form of one or more messages (e.g., one or more HTTP messages) that are sent over the communication path 106 between the back-end computing platform 102 and the client device 104 and, in at least some implementations, the communication may comprise be sent via one or more APIs. Alternatively, in an implementation where the client device 104 determines the first of input-control elements to include in the unified user interface, this function may involve the client device 104 updating the unified user interface such that it includes the second set of input-control elements determined locally by the client device 104.

The function of causing the unified user interface to be updated to include the second set of input-control elements determined by the computing system along with any previously-entered values that are to be pre-populated into the second set of input-control elements may take other forms as well, including but not limited to the possibility that the second set of input-control elements may not be pre-populated with any previously-entered values in a scenario where the previously-entered values were for data fields in the first set that do not map to any corresponding data fields in the second set.

To illustrate with an example, FIG. 6B shows an example GUI view 600B comprising an updated instance of the unified user interface shown in FIG. 4C and/or FIG. 6A that now includes an example second set of input-control elements for the second set of data fields corresponding to the second type of data object, which is a punch item type of data object in this example. As shown, the first set of input control elements may include, but are not limited to including, a text box 612A that enables the user to input a title for the punch item type of data object, a dropdown list 614A that enables the user to input identification of a manager for the punch item type of data object, a dropdown list 614B that enables the user to input identification of an assignee for the punch item type of data object, a text box 612B that enables the user to input a description for the punch item type of data object, and one or more uploaders 620 that enable the user to upload files (such as images, videos, recordings, etc.) for the punch item type of data object, among other possible input-control elements that may be included for other possible data fields corresponding to the punch item type of data object.

When the GUI view 600B is viewed in comparison to the GUI view 400C of FIG. 4C, one can see that the first set of input-control elements (e.g., text box 412A, dropdown list 414B, text box 412B, uploader(s) 420, etc.) and the second set of input control elements (e.g., the text box 612A, the dropdown list 614A, the dropdown list 614B, the text box 612B, uploader(s) 620, etc.) include some input-control elements that are either common or similar (e.g., the text boxes 412A, 612B both enable the user to input a title for the new data object, the text boxes 412A, 612A both enable the user to input a description for the new data object, the uploader(s) 420, 620 may both enable the user to upload similar types of content, etc.). Based on these correlations, when the unified user interface is updated to include the second set of input control elements (as seen in the GUI view 600C), the data values that were previously entered into the text boxes 412A, 412B in the GUI view 400C of FIG. 4C are now populated in the text boxes 612A, 612B and, thus, are the same data values in both referenced GUI views 400C, 600B.

At block 506 of FIG. 5, the computing system may then receive additional values for at least some data fields of the data object to be created that have been input by the user into the unified user interface (e.g., via the second set of input-control elements included within the unified user interface). In practice, this may take the form of the user interacting with the input-control elements of the unified user interface in order to input the values for the second set of data fields corresponding to the second type of data object. For example, the user may input the values for the first set of data fields by tapping, clicking on, or typing within the first set of input-control elements, among other possible ways that the user may input values into the unified user interface (e.g., a voice-based input).

For instance, the client device 104 may receive the user's input of the values for the data object to be created via one or more I/O components of the client device 104, and in at least some implementations, the client device 104 may then transmit a communication that encodes the user's input of the values for the data object to be created to the back-end computing platform 102, which may thereafter receive the communication. In practice, this communication may take the form of one or more messages (e.g., one or more HTTP messages) that are sent over the communication path 106 between the client device 104 and the back-end computing platform 102 and, in at least some implementations, the communication may be sent via one or more APIs.

The function of receiving values for the data object to be created that have been input by the user into the unified user interface may take various other forms as well.

After the user inputs a change to the type of data object to be created and continues inputting values for the data object into the unified user interface, the unified user interface may enable the user to proceed along one of a few different paths related to the creation of the data object.

For instance, as a first possible path, the unified user interface may enable the user to input values for all required data fields of the data object of the second type and then input a request to create the data object, and to facilitate this path, the computing system may function to (i) receive the request to create the data object, and then (ii) create the data object of the second type based on the values into by the user into the unified user interface. For instance, the client device 104 may receive the user's request to create the data object via one or more I/O components of the client device 104, and the client device 104 may in turn transmit a communication that encodes the user's request to create the data object (perhaps along with some or all of the values input by the user to the extent that they were not sent previously) to the back-end computing platform 102, which may thereafter receive the communication and then create the data object based on the values input by the user into the unified user interface. In practice, this communication may take the form of one or more messages (e.g., one or more HTTP messages) that are sent over the communication path 106 between the client device 104 and the back-end computing platform 102 and, in at least some implementations, the communication may be sent via one or more APIs. Additionally, the back-end computing platform 102 may store the newly-created data object for use and/or access by users of the construction management software application within a data storage layer of the back-end computing platform 102.

Alternatively, as a second possible path, the unified user interface may enable the user to again change the user's selection of the type of data object to be created before completing the creation process, and to facilitate this path, the computing system may function to update the unified user interface so as to enable the user to input values for a further-updated set of data fields that correspond to the newly-selected type of data object while mapping any previously-entered values to the further-updated set of data fields.

As discussed above, yet another aspect of the functionality that is provided by the disclosed software technology may include functionality that predicts which type of data object should be created based on an evaluation of the values input by the user into the unified user interface for a data object to be created and then uses that prediction as a basis for facilitating the creation of the data object. In accordance with the present disclosure, such a prediction of which type of data object should be created may be made at a time when the user has not yet selected a type of data object to be created via the unified user interface (e.g., if a user begins input values into the unified user interface without first selecting a type of data object), or at a time when the user had already previously selected a type of data object to be created via the unified user interface, in which case the prediction may lead to a change in the selected type of data object along with a change in the input-control elements that are presented via the unified user interface.

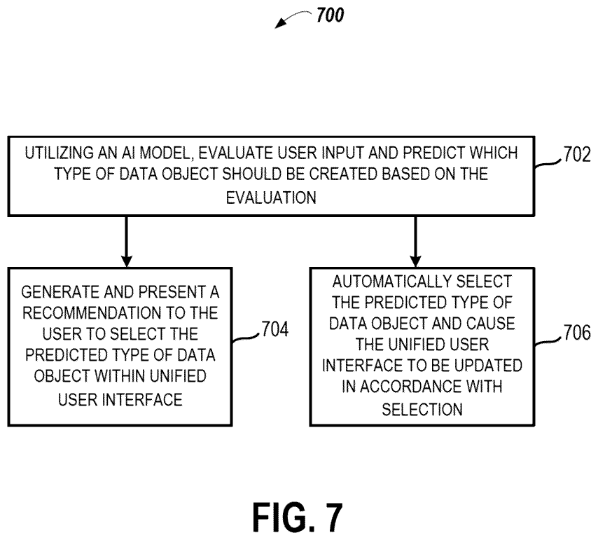

Turning now to FIG. 7, example functionality 700 for predicting which type of data object should be created based on an evaluation of values for a data object to be created that are input by the user via the unified user interface and then using that prediction as a basis for facilitating the creation of the data object. For purposes of illustration, the example functionality 700 of FIG. 7 is described below as being carried out by a computing system that comprises (i) the back-end computing platform 102 running the back-end software for a construction management software application and (ii) a given one of the client devices running the front-end software for the construction management software application. In this respect, each of the functions described below may be carried out by the back-end computing platform 102, the client device 104, or a combination thereof. However, it should be understood that the example functionality 700 may be carried out by other types of computing systems as well (e.g., a standalone client device). Further, it should be understood that the example functionality 700 of FIG. 7 is merely described in this manner for the sake of clarity and explanation and that the example functionality may be implemented in various other manners, including the possibility that functions may be added, removed, rearranged into different orders, combined into fewer blocks, and/or separated into additional blocks depending upon the particular example.

The example functionality 700 may pick up after either (i) block 312 of FIG. 3, which involves the computing system receiving values for at least some data fields of the data object to be created that have been input by the user into the unified user interface at a time when the type of data object is set to the first type of data object that was selected by the user in one of the manners described above, or (ii) block 506 of FIG. 5, which involves the computing system receiving additional values for at least some data fields of the data object to be created that have been input by the user into the unified user interface at a time when the type of data object is set to the second type of data object that was selected by the user in one of the manners described above.

As shown in FIG. 7, the example functionality 700 may begin at block 702 with the computing system utilizing an AI model to predict which type of data object should be created based on an evaluation of the received values for the data object. The AI model that is utilized to predict which type of data object should be created based on an evaluation of the received values for the data object may take the form of any AI model that is capable of generating a prediction of which type of data object related to construction management is to be created based on an evaluation of values that have been input for the data object. For instance, in one implementation, the AI model may comprise a generative AI model, examples of which may include a transformer-based model such as a small-language, large-language, and/or large-multimodal model, a diffusion model, a generational adversarial network (GAN) model, and a variational-autoencoder model. In this respect, the generative AI model could be a pre-trained generative AI model (e.g., an “off-the-shelf” generative AI model, such as a GPT type of generative AI model, a BERT type of generative AI model, a BART type of generative AI model, a T5 type of generative AI model, a PEGASUS type of generative AI model, a Llama type of generative AI model, or Phi-2 or Phi-3 type of generative AI model, among other examples), which may or may not be further trained (e.g., via fine tuning or the like) to generate the data-object predictions discussed herein, or may comprise a generative AI model that is trained in the first instance to generate the data-object predictions discussed herein, among other possibilities.

In another implementation, the AI model may comprise any of various types of discriminative AI models that may be trained via a machine learning process to generate the data-object predictions discussed herein, examples of which may include a decision-tree model (e.g., a Random Forest model or a gradient-boosted decision tree (GBDT) model), a neural-network-based model (e.g., a neural-network-based model that is configured to receive unstructured input such as unstructured text, images, audio, etc.), a regression model (e.g., derived via Lasso regression, logistic regression, linear regression, polynomial regression, etc.), a nearest-neighbor model (e.g., k-nearest neighbor, BallTree, KDTree, etc.), a support vector machine (SVM) model, and/or a Bayesian model (e.g., a Bayesian belief network), among other possibilities. In this respect, the computing system may function to train the discriminative AI model by applying a machine learning process to training data that includes (i) values that have been input for data objects and (ii) corresponding ground-truth types for the data objects.

The AI model that is utilized to predict which type of data object should be created based on an evaluation of the received values for the data object may take other forms as well, including but not limited to the possibility that multiple AI models may be utilized in combination to generate the data-type predictions. In alternative implementations, it may also be possible to utilize a rule-based model rather than an AI model to predict which type of data object should be created.

Further, the function of utilizing the AI model to predict which type of data object should be created may take various forms, which may depend in part on the type of AI model that is utilized. For example, if the AI model is a generative AI model, the function of utilizing the AI model to predict which type of data object should be created may involve (i) generating a prompt for the generative AI model that comprises a request to predict which type of data object should be created based on a set of values that have been input for the data object, (ii) passing the prompt as input to the generative AI model (which may be hosted on the back-end computing platform 102, the client device, or an external computing system), and (iii) receiving a response from the AI model comprising the prediction of which type of data object should be created. As another example, if the AI model is a discriminative AI model, the function of utilizing the AI model to predict which type of data object should be created may involve (i) generating a set of feature data for the discriminative AI model that comprises a set of values that have been input for the data object, (ii) passing the feature data as input to the discriminative AI model (which may be hosted on the back-end computing platform 102, the client device 104, or an external computing system), and (iii) receiving the output of the discriminative AI model, which comprises the prediction of which type of data object should be created. The function of utilizing the AI model to predict which type of data object should be created may take other forms as well.

Further yet, the function of utilizing the AI model to predict which type of data object should be created may be carried out at any of various times by either the back-end computing platform 102, the client device 104, or both. For instance, as one possibility, the function of utilizing the AI model to predict which type of data object should be created may be carried out by the back-end computing platform 102 and/or the client device 104 on an iterative (and ongoing) basis each time the user inputs a new value for the data object. As another possibility, the function of utilizing the AI model to predict which type of data object should be created may be carried out by the back-end computing platform 102 and/or the client device 104 in response to certain trigger events that may occur during the process of creating the data object, such as the input of values for certain types of data fields and/or a certain threshold extent of data fields. The function of utilizing the AI model to predict which type of data object should be created may be carried out by the back-end computing platform 102 and/or the client device 104 at other times as well.

After utilizing the AI model to predict which type of data object should be created, this prediction may then be used by the computing system to facilitate selection of the type of data object to be created. This functionality may take any of various forms, two examples of which are described below with respect to blocks 704 and 706.

For instance, at block 704, the computing system may utilize the prediction of which type of data object should be created as a basis for presenting the user with a recommendation to select the predicted type of data object as the type of data object to be created. This function may take any of various forms.

For instance, in an implementation where the back-end computing platform 102 utilizes the AI model to predict which type of data object should be created, the function of presenting the user with a recommendation to select the predicted type of data object as the type of data object to be created may involve (i) the back-end computing platform 102 transmitting a communication to the client device 104 that instructs the client device 104 to update the unified user interface to include the recommendation to select the predicted type of data object as the type of data object to be created as determined by the back-end computing platform 102, (ii) the client device 104 receiving the communication, and (iii) the client device 104 thereafter updating the unified user interface such that it includes the recommendation to select the predicted type of data object as the type of data object to be created. In practice, this communication may take the form of one or more messages (e.g., one or more HTTP messages) that are sent over the communication path 106 between the back-end computing platform 102 and the client device 104 and, in at least some implementations, the communication may comprise be sent via one or more APIs. Alternatively, in an implementation where the client device 104 utilizes the AI model to predict which type of data object should be created, the function of presenting the user with a recommendation to select the predicted type of data object as the type of data object to be created may involve may involve the client device 104 updating the unified user interface such that it includes the recommendation to select the predicted type of data object as the type of data object to be created as determined locally by the client device 104.

The function of presenting the user with the recommendation to select the predicted type of data object as the type of data object to be created may take the form of an AI-powered digital assistant within the construction management software application that may present the user with the recommendation to select the predicted type of data object as the type of data object to be created. However, the function of presenting the user with the recommendation to select the predicted type of data object as the type of data object to be created may take various other forms as well.

Further, the recommendation to select the predicted type of data object that is presented to the user may take any of various forms. For instance, as one possibility, the recommendation may be presented in the form of a popup shown within the unified user interface that includes a text-based recommendation to select the predicted type of data object, perhaps along with a selectable button that, when selected, causes the predicted type of data object to be selected. As another possibility, the recommendation may be presented in the form of highlighting that is applied to the predicted type of data object within a list of type options that may be presented via the type-selection input-control element of the unified user interface. The recommendation to select the predicted type of data object that is presented to the user may take other forms as well.

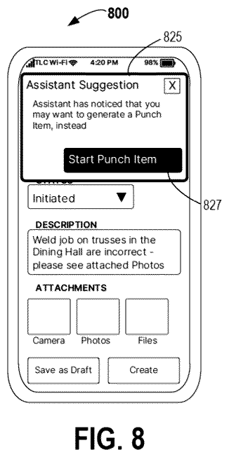

FIG. 8 shows an example GUI view 800A comprising a unified user interface that has been updated to include a recommendation to select a predicted type of data object as the type of data object to be created, which takes the form of a popup 825 shown within the unified user interface. As shown in FIG. 8A, the popup 825 a text-based recommendation to select the predicted type of data object, which in this example is a punch item type of data object.

Additionally, as shown in FIG. 8, the popup 825 may include a selectable button 827 that enables the user to accept the presented recommendation. In particular, the selectable button 827, when selected, may be interpreted by the computing system as a selection by the user of punch item as the type of data object to be created, and the computing system may then carry out functionality similar to that described above with reference to blocks 504-506 of FIG. 5 (e.g., causing the unified user interface to be updated based on the selection of the type of data object and then receiving values for the selected type of data object).

Returning to FIG. 7, at block 706, the computing system may utilize the prediction of which type of data object should be created as a basis for (i) automatically selecting the predicted type of data object as the type of data object to be created and (ii) causing the unified user interface to be updated in accordance with this automatic selection. This function may take any of various forms.

For instance, in an implementation where the back-end computing platform 102 utilizes the AI model to predict which type of data object should be created, this function may involve the back-end computing platform 102 designating the predicted type of data object as the selected type of data object to be created and then causing the unified user interface to be updated in accordance with this newly-selected type of data object, which may involve back-end functionality similar to that described above with reference to blocks 504-506 of FIG. 5 (e.g., causing the unified user interface to be updated based on the selection of the type of data object, perhaps with mapping of previously-input values, and then receiving values for the selected type of data object).

Alternatively, in an implementation where the client device 104 utilizes the AI model to predict which type of data object should be created, this function may involve the client device 104 designating the predicted type of data object as the selected type of data object to be created and then causing the unified user interface to be updated in accordance with this newly-selected type of data object, which may involve front-end functionality similar to that described above with reference to blocks 504-506 of FIG. 5 (e.g., causing the unified user interface to be updated based on the selection of the type of data object, perhaps with mapping of previously-input values, and then receiving values for the selected type of data object). The function of automatically selecting the predicted type of data object as the type of data object to be created and then causing the unified user interface to be updated in accordance with this automatic selection may take other forms as well.

After the type of data object to be created is updated in accordance with the AI-based recommendation or the AI-based selection and the user continues inputting values for the data object into the unified user interface, the unified user interface may enable the user to proceed along one of a few different paths related to the creation of the data object.

For instance, as a first possible path, the unified user interface may enable the user to input values for all required data fields of the data object of the updated type and then input a request to create the data object, and to facilitate this path, the computing system may function to (i) receive the request to create the data object, and then (ii) create the data object of the updated type based on the values into by the user into the unified user interface. For instance, the client device 104 may receive the user's request to create the data object via one or more I/O components of the client device 104, and the client device 104 may in turn transmit a communication the encodes the user's request to create the data object (perhaps along with some or all of the values input by the user to the extent that they were not sent previously) to the back-end computing platform 102, which may thereafter receive the communication and then create the data object based on the values input by the user into the unified user interface. In practice, this communication may take the form of one or more messages (e.g., one or more HTTP messages) that are sent over the communication path 106 between the client device 104 and the back-end computing platform 102 and, in at least some implementations, the communication may comprise be sent via one or more APIs. Additionally, the back-end computing platform 102 may store the newly-created data object for use and/or access by users of the construction management software application within a data storage layer of the back-end computing platform 102.

Alternatively, as a second possible path, the unified user interface may enable the type of data object to be further updated based on user input (as described with respect to FIG. 5) and/or based on a further AI-based recommendation or selection (as described with respect to FIG. 7) before completing the creation process, and to facilitate this path, the computing system may function to update the unified user interface so as to enable the user to input values for a further-updated set of data fields that correspond to the newly-selected type of data object while mapping any previously-entered values to the further-updated set of data fields.

While the disclosed software technology of is described in the context of a construction management software application, the disclosed software technology could also be utilized to create different types of data objects within any other category of software application that supports multiple different types of data objects.

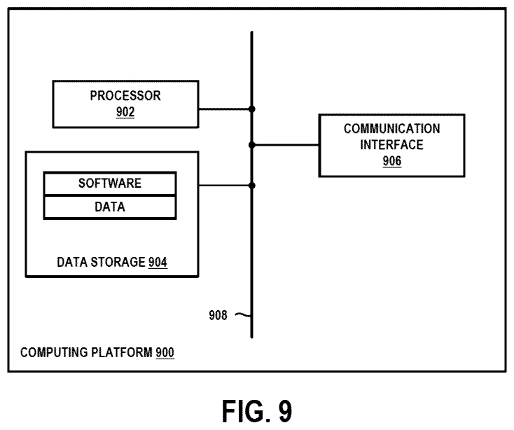

Turning now to FIG. 9, a simplified block diagram is provided to illustrate some structural components that may be included in an example computing platform 900 that may be configured to perform the platform-side functions disclosed herein. At a high level, the example computing platform 900 may generally comprise any one or more computer systems (e.g., one or more servers) that collectively include one or more processors 902, data storage 904, and one or more communication interfaces 906, each of which may be communicatively linked by a communication link 908 that may take the form of a system bus, a communication network such as a public, private, or hybrid cloud, or some other connection mechanism. Each of these components may take various forms.

For instance, the one or more processors 902 may comprise one or more processor components, such as one or more central processing units (CPUs), graphics processing units (GPUs), application-specific integrated circuits (ASICs), digital signal processor (DSPs), and/or programmable logic devices such as field programmable gate arrays (FPGAs), among other possible types of processing components. In line with the discussion above, it should also be understood that the one or more processors 902 could comprise processing components that are distributed across a plurality of physical computing devices connected via a network, such as a computing cluster of a public, private, or hybrid cloud.

In turn, the data storage 904 may comprise one or more non-transitory computer-readable storage mediums, examples of which may include volatile storage mediums such as random-access memory, registers, cache, etc. and non-volatile storage mediums such as read-only memory, a hard-disk drive, a solid-state drive, flash memory, an optical-storage device, etc. In line with the discussion above, it should also be understood that the data storage 904 may comprise computer-readable storage mediums that are distributed across a plurality of physical computing devices connected via a network, such as a storage cluster of a public, private, or hybrid cloud that operates according to technologies such as AWS for Elastic Compute Cloud, Simple Storage Service, etc.

As shown in FIG. 9, the data storage 904 may be capable of storing both (i) program instructions that are executable by the one or more processors 902 such that the example computing platform 900 is configured to perform any of the various functions disclosed herein (including but not limited to any of the platform-side functions discussed above), and (ii) data that may be received, derived, or otherwise stored by the example computing platform 900.

The one or more communication interfaces 906 may comprise one or more interfaces that facilitate communication between the example computing platform 900 and other systems or devices, where each such interface may be wired and/or wireless and may communicate according to any of various communication protocols. As examples, the one or more communication interfaces 906 may take include an Ethernet interface, a serial bus interface (e.g., Firewire, USB 3.0, etc.), a chipset and antenna adapted to facilitate any of various types of wireless communication (e.g., Wi-Fi communication, cellular communication, Bluetooth® communication, etc.), and/or any other interface that provides for wireless or wired communication. Other configurations are possible as well.

Although not shown, the example computing platform 900 may additionally have an Input/Output (I/O) interface that includes or provides connectivity to I/O components that facilitate user interaction with the example computing platform 900, such as a keyboard, a mouse, a trackpad, a display screen, a touch-sensitive interface, a stylus, a virtual-reality headset, and/or one or more speaker components, among other possibilities.

It should be understood that the example computing platform 900 is one example of a computing platform that may be used with the examples described herein. Numerous other arrangements are possible and contemplated herein. For instance, in other examples, the example computing platform 900 may include additional components not pictured and/or more or less of the pictured components.

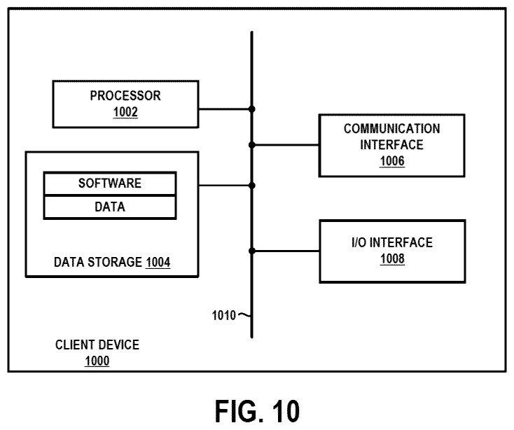

Turning next to FIG. 10, a simplified block diagram is provided to illustrate some structural components that may be included in an example client device 1000 that may be configured to perform some the client-side functions disclosed herein. At a high level, the example client device 1000 may include one or more processors 1002, data storage 1004, one or more communication interfaces 1006, and an I/O interface 1008, each of which may be communicatively linked by a communication link 1010 that may take the form a system bus and/or some other connection mechanism. Each of these components may take various forms.

For instance, the one or more processors 1002 of the example client device 800 may comprise one or more processor components, such as one or more CPUs, GPUs, ASICs, DSPs, and/or programmable logic devices such as FPGAs, among other possible types of processing components.

In turn, the data storage 1004 of the example client device 1000 may comprise one or more non-transitory computer-readable mediums, examples of which may include volatile storage mediums such as random-access memory, registers, cache, etc. and non-volatile storage mediums such as read-only memory, a hard-disk drive, a solid-state drive, flash memory, an optical-storage device, etc. As shown in FIG. 10, the data storage 1004 may be capable of storing both (i) program instructions that are executable by the one or more processors 1002 of the example client device 800 such that the example client device 1000 is configured to perform any of the various functions disclosed herein (including but not limited to any of the client-side functions discussed above), and (ii) data that may be received, derived, or otherwise stored by the example client device 800.

The one or more communication interfaces 1006 may comprise one or more interfaces that facilitate communication between the example client device 1000 and other systems or devices, where each such interface may be wired and/or wireless and may communicate according to any of various communication protocols. As examples, the one or more communication interfaces 1006 may take include an Ethernet interface, a serial bus interface (e.g., Firewire, USB 3.0, etc.), a chipset and antenna adapted to facilitate any of various types of wireless communication (e.g., Wi-Fi communication, cellular communication, Bluetooth® communication, etc.), and/or any other interface that provides for wireless or wired communication. Other configurations are possible as well.

The I/O interface 008 may generally take the form of (i) one or more input interfaces that are configured to receive and/or capture information at the example client device 1000 and (ii) one or more output interfaces that are configured to output information from the example client device 1000 (e.g., for presentation to a user). In this respect, the one or more input interfaces of I/O interface may include or provide connectivity to input components such as a microphone, a camera, a keyboard, a mouse, a trackpad, a touchscreen, and/or a stylus, among other possibilities, and the one or more output interfaces of the I/O interface 1008 may include or provide connectivity to output components such as a display screen and/or an audio speaker, among other possibilities.

It should be understood that the example client device 1000 is one example of a client device that may be used with the examples described herein. Numerous other arrangements are possible and contemplated herein. For instance, in other examples, the example client device 1000 may include additional components not pictured and/or more or fewer of the pictured components.

IV. CONCLUSION

Example embodiments of the disclosed innovations have been described above. Those skilled in the art will understand, however, that changes and modifications may be made to the embodiments described without departing from the true scope and spirit of the present invention, which will be defined by the claims.

Further, to the extent that examples described herein involve operations performed or initiated by actors, such as “humans,” “operators,” “users,” or other entities, this is for purposes of example and explanation only. The claims should not be construed as requiring action by such actors unless explicitly recited in the claim language.

What is claimed is:

1. A computing platform comprising:
at least one processor;
at least one non-transitory computer-readable medium; and
program instructions stored on the at least one non-transitory computer-readable medium that, when executed by the at least one processor, cause the computing platform to:
cause a user to be presented with a unified user interface for creating data objects of multiple different types, wherein the unified user interface comprises a type-selection input-control element that enables the user to input a selection of a type of data object to create;
receive an indication that the user has selected a first type of data object via the type-selection input-control element within the unified user interface;
cause the unified user interface to be updated to include a first set of input-control elements for inputting values for a first set of data fields corresponding to the first type of data object;
receive a first set of values for the first set of data fields that are input by the user via the first set of input-control elements;
receive an indication that the selection of the type of data object to create has been changed from the first type of data object to a second type of data object;
cause the unified user interface to be updated to include a second set of input-control elements for inputting values for a second set of data fields corresponding to the second type of data object, where at least a subset of the second set of data fields are pre-populated with at least a subset of the first set of values that were previously input by the user based on a mapping between the first and second sets of data fields;
receive a second set of one or more values for the second set of data fields that are input by the user via the second set of input-control elements; and
create the data object of the second type based on the first and second sets of values.

2. The computing platform of claim 1, further comprising program instructions stored on the at least one non-transitory computer-readable medium that, when executed by the at least one processor, cause the computing platform to:
after receiving the first set of values for the first set of data fields, utilize an artificial intelligence (AI) model to generate a prediction of which type of data object should be created based on an evaluation of the values input by the user.

3. The computing platform of claim 2, further comprising program instructions stored on the at least one non-transitory computer-readable medium that, when executed by the at least one processor, cause the computing platform to:
based on the prediction, update the unified user interface to present a recommendation to the user to select the predicted type of data object.

4. The computing platform of claim 2, further comprising program instructions stored on the at least one non-transitory computer-readable medium that, when executed by the at least one processor, cause the computing platform to:
based on the prediction, automatically change the selection of the type of data object to create from the first type of data object to a second type of data object and correspondingly generate the indication that that the selection of the type of data object to create has been changed from the first type of data object to a second type of data object.

5. The computing platform of claim 2, wherein the AI model comprises a generative AI model.

6. The computing platform of claim 1, wherein:
the first set of values for the first set of data fields consists of values for less than all of the first set of data fields; and
the second set of values for the second set of data fields consists of values for less than all of the second set of data fields.

7. The computing platform of claim 1, wherein the mapping between the first and second sets of data fields comprises a mapping between each of at least a subset of data fields in the first set and a corresponding data field in the second set.

8. The computing platform of claim 1, wherein the type-selection input-control element comprises a dropdown list.

9. The computing platform of claim 1, wherein the first set of input-control elements and the second set of input-control elements comprise at least one common data field having a same field name.

10. A non-transitory computer-readable medium having stored thereon program instructions that, when executed by at least one processor, cause a computing platform to:
cause a user to be presented with a unified user interface for creating data objects of multiple different types, wherein the unified user interface comprises a type-selection input-control element that enables the user to input a selection of a type of data object to create;
receive an indication that the user has selected a first type of data object via the type-selection input-control element within the unified user interface;
cause the unified user interface to be updated to include a first set of input-control elements for inputting values for a first set of data fields corresponding to the first type of data object;
cause the unified user interface to be updated to include a first set of input-control elements for inputting values for a first set of data fields corresponding to the first type of data object;
receive an indication that the selection of the type of data object to create has been changed from the first type of data object to a second type of data object;
cause the unified user interface to be updated to include a second set of input-control elements for inputting values for a second set of data fields corresponding to the second type of data object, where at least a subset of the second set of data fields are pre-populated with at least a subset of the first set of values that were previously input by the user based on a mapping between the first and second sets of data fields;
receive a second set of one or more values for the second set of data fields that are input by the user via the second set of input-control elements; and
create the data object of the second type based on the first and second sets of values.

11. The non-transitory computer-readable medium of claim 10, wherein the non-transitory computer-readable medium also has stored thereon program instructions that, when executed by at least one processor, cause the computing platform to:
after receiving the first set of values for the first set of data fields, utilize an artificial intelligence (AI) model to generate a prediction of which type of data object should be created based on an evaluation of the values input by the user.

12. The non-transitory computer-readable medium of claim 11, wherein the non-transitory computer-readable medium also has stored thereon program instructions that, when executed by at least one processor, cause the computing platform to:
based on the prediction, update the unified user interface to present a recommendation to the user to select the predicted type of data object.

13. The non-transitory computer-readable medium of claim 11, wherein the non-transitory computer-readable medium also has stored thereon program instructions that, when executed by at least one processor, cause the computing platform to:
based on the prediction, automatically change the selection of the type of data object to create from the first type of data object to a second type of data object and correspondingly generate the indication that that the selection of the type of data object to create has been changed from the first type of data object to a second type of data object.

14. The non-transitory computer-readable medium of claim 11, wherein the AI model comprises a generative AI model.

15. The non-transitory computer-readable medium of claim 10, wherein the mapping between the first and second sets of data fields comprises a mapping between each of at least a subset of data fields in the first set and a corresponding data field in the second set.

16. The non-transitory computer-readable medium of claim 10, wherein the first set of set of input-control elements and the second set of input-control elements comprise at least one common data field having a same field name.

17. A method carried out by a computing platform, the method comprising:
causing a user to be presented with a unified user interface for creating data objects of multiple different types, wherein the unified user interface comprises a type-selection input-control element that enables the user to input a selection of a type of data object to create;
receiving an indication that the user has selected a first type of data object via the type-selection input-control element within the unified user interface;
causing the unified user interface to be updated to include a first set of input-control elements for inputting values for a first set of data fields corresponding to the first type of data object;
causing the unified user interface to be updated to include a first set of input-control elements for inputting values for a first set of data fields corresponding to the first type of data object;
receiving an indication that the selection of the type of data object to create has been changed from the first type of data object to a second type of data object;
causing the unified user interface to be updated to include a second set of input-control elements for inputting values for a second set of data fields corresponding to the second type of data object, where at least a subset of the second set of data fields are pre-populated with at least a subset of the first set of values that were previously input by the user based on a mapping between the first and second sets of data fields;
receiving a second set of one or more values for the second set of data fields that are input by the user via the second set of input-control elements; and
creating the data object of the second type based on the first and second sets of values.

18. The method of claim 17, further comprising:
after receiving the first set of values for the first set of data fields, utilizing an artificial intelligence (AI) model to generate a prediction of which type of data object should be created based on an evaluation of the values input by the user.

19. The method of claim 17, wherein the mapping between the first and second sets of data fields comprises a mapping between each of at least a subset of data fields in the first set and a corresponding data field in the second set.

20. The method of claim 17, wherein the first set of set of input-control elements and the second set of input-control elements comprise at least one common data field having a same field name.
